(19) United States
(12) Patent Application Publication
(10) Pub. No.: US 2009/0312050 A1
(43) Pub. Date: Dec. 17, 2009

(54) MULTI-BAND MOBILE COMMUNICATION DEVICE

(75) Inventors: CHING-CHUNG TANG, Taipei (TW); KUO-CHU LIAO, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTEK COMPUTER INC., Taipei (TW)

(21) Appl. No.: 12/476,625

(22) Filed: Jun. 2, 2009

(30) Foreign Application Priority Data
Jun. 13, 2008 (TW) 097122225

(51) Int. Cl. H04M 1/00

(52) U.S. Cl. 455/553.1

(57) ABSTRACT

A multi-band communication device includes a first wireless signal processing circuit, a second wireless signal processing circuit, an antenna switch module, a first antenna unit and a second antenna unit. The first wireless signal processing circuit is used for operating multiple first band signals. The second wireless signal processing circuit is used for operating multiple second band signals. The antenna switch module is in communication with the first wireless signal processing circuit and the second wireless signal processing circuit for switching the first band signals and a first portion of the second band signals. The first antenna unit is in communication with the antenna switch module. The second antenna unit is in communication with the second wireless signal processing circuit.

### FIELD OF THE INVENTION

The present invention relates to a multi-band communication device, and more particularly to a multi-band communication device including two wireless signal processing circuits and two antenna units, in which one antenna unit transports signals in a specified frequency band and the other antenna unit transports signals in another frequency band.

### BACKGROUND OF THE INVENTION

Nowadays, portable electronic devices such as mobile phones become essential electronic products because they are usable wherever and whenever the users are. Recently, with increasing development of mobile computing technologies and electronic communication technologies, the mobile phones have enhanced transportation quality and improved signal processing mechanisms in order to provide better communication service and more operating applications.

According to the history and coverage area of the communication technologies, GSM (Global System for Mobile Communications) and CDMA (Code Division Multiple Access) are widely used. In the early stage, GSM is developed as a standard for a mobile telephone system that could be used across Europe. Initially, CDMA is used for America military communication applications. Recently, CDMA2000 and other 3G CDMA enhancement standards are used in commercial telecommunication systems. Due to some factors such as market shares, number of users or related supporting technologies, GSM becomes the most popular standard for mobile phones in the world.

As known, GSM system and CDMA system are different communication systems. For complying with different radio frequency allocation methods in different countries, the signal transmission (Tx) and signal reception (Rx) are performed in multiple frequency bands. For example, the GSM system is usually operated in the 850, 900, 1800 or 1900 MHz frequency bands. A single antenna switch module is employed to select a proper operating frequency band from different wireless signal processing circuits, so that signals are transmitted and received via a common antenna unit.

In the development of the mobile communication systems, the GSM standard is a second generation (2G) mobile communication standard classified by ITU (International Communications Union); and a WCDMA (Wideband Code Division Multiple Access) standard is a third (3G) mobile communication standard developed according to the GSM system. The current WCDMA system can be operated in any frequency band. Since the mobile communication standards and the mobile communication technologies are gradually developed and revised, the mobile phones need to be updated or otherwise weeded out.

As previously described, CDMA2000 and other 3G CDMA enhancement standards are America standards, so that these standards are harmonized or compatible with each other. Similarly, since the WCDMA system and the GSM system are European communication systems, the WCDMA system and the GSM system are harmonized or compatible with each other. For example, some base stations of the WCDMA system can be shared in the GSM system. In accordance with the trend of designing mobile phones, a second generation (2G) mobile communication system and a third (3G) mobile communication standard communication system are integrated into a single mobile phone. Moreover, a common antenna unit is used for transmitting and receiving signals.

FIG. 1 is a schematic functional block diagram illustrating a mobile phone integrating the WCDMA system and the GSM system. As shown in FIG. 1, the mobile phone 100 principally comprises an antenna unit 10, an antenna switch module 11, a GSM wireless signal processing circuit 12 and a WCDMA wireless signal processing circuit 14. The signal transmission (Tx) and signal reception (Rx) of the GSM wireless signal processing circuit 12 and the WCDMA wireless signal processing circuit 14 are performed in different frequency bands. For example, the signal transmission (Tx) of the GSM wireless signal processing circuit 12 is performed in the 850/900 MHz or 1800/1900 MHz frequency bands. The signal reception (Rx) of the GSM wireless signal processing circuit 12 is performed in the 850, 900, 1800 or 1900 MHz frequency bands. The signal transmission (Tx) and signal reception (Rx) of the WCDMA wireless signal processing circuit 14 are performed in three frequency bands, e.g. Band-I (2100 MHz), Band-II (1900 MHz) and Band-V (850 MHz). The antenna switch module 11 is used for switching the operating frequency bands of the GSM wireless signal processing circuit 12 and the WCDMA wireless signal processing circuit 14. As a consequence, the wireless signals operated in all frequency bands by the GSM wireless signal processing circuit 12 and the WCDMA wireless signal processing circuit 14 can be transmitted and received through the antenna unit 10.

In accordance with the trend of designing mobile phones, different mobile communication systems are integrated into a single mobile phone. As a consequence, the integrated mobile phone can be operated in multi-bands for transmitting and receiving signals. Take a 3G WCDMA system for example. Since the antenna switch module 11 is required for switching a specified frequency band of transporting signals through the antenna unit 10, the power value of the signal is reduced, which is also referred as insertion loss. As known, several Decibel (dB) units of insertion loss adversely could influence the performance of transporting signals.

According to another mobile communication technology, the WCDMA system and the GSM system are separated from each other. The WCDMA system and the GSM system transport signals through different antenna units. FIG. 2 is a schematic functional block diagram illustrating another mobile phone. As shown in FIG. 2, the mobile phone 200 includes an antenna switch module 21 and a frequency division filter 22. A first antenna unit 20 is in communication with the antenna switch module 21. A second antenna unit 23 is in communication with the frequency division filter 22. The antenna switch module 21 and the first antenna unit 20 are used for transmitting and receiving GSM signals and WCDMA signals in specified frequency bands. The frequency division filter 22 and the second antenna unit 23 are used for transmitting and receiving WCDMA signals in specified frequency bands. In practice, the power loss of the signals generated by the frequency division filter 22 becomes more serious. Moreover, since the first antenna unit 20 and the second antenna unit 23 respectively in communication with the antenna switch module 21 and the frequency division filter 22 are switched in multiple frequency bands, the performance of transporting the WCDMA signals in some frequency bands will be deteriorated. The associated technologies of FIG. 2 are disclosed in for example US Patent Publication No. US 2006/0135210 A1.

### SUMMARY OF THE INVENTION

The present invention relates to a multi-band communication device. The multi-band communication device includes a first wireless signal processing circuit, a second wireless signal processing circuit, an antenna switch module, a first antenna unit and a second antenna unit. The first wireless signal processing circuit is used for operating multiple first band signals. The second wireless signal processing circuit is used for operating multiple second band signals. The antenna switch module is in communication with the first wireless signal processing circuit and the second wireless signal processing circuit for switching the first band signals and a first portion of the second band signals. The first antenna unit is in communication with the antenna switch module. The second antenna unit is in communication with the second wireless signal processing circuit.

In the multi-band communication device of the present invention, one antenna unit is used to transport signals in a specified frequency band of the WCDMA system and the other antenna is used to transport signals in the frequency bands of the GSM system and another frequency band of the WCDMA system. Since the transmission power loss is reduced during the processes of switching the frequency bands of the WCDMA system and transporting signals, the performance of transporting signals is enhanced.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating an integrated circuit board according to a preferred embodiment of the present invention;

FIG. 2 is a schematic functional block diagram illustrating another mobile phone; and

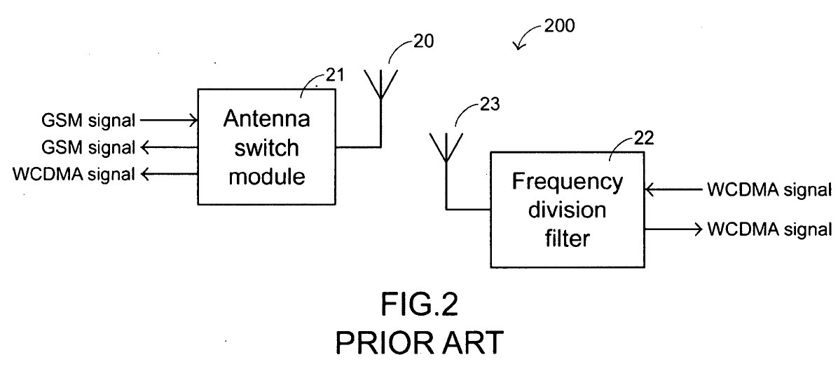

FIG. 3 is a schematic functional block diagram illustrating a mobile phone according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

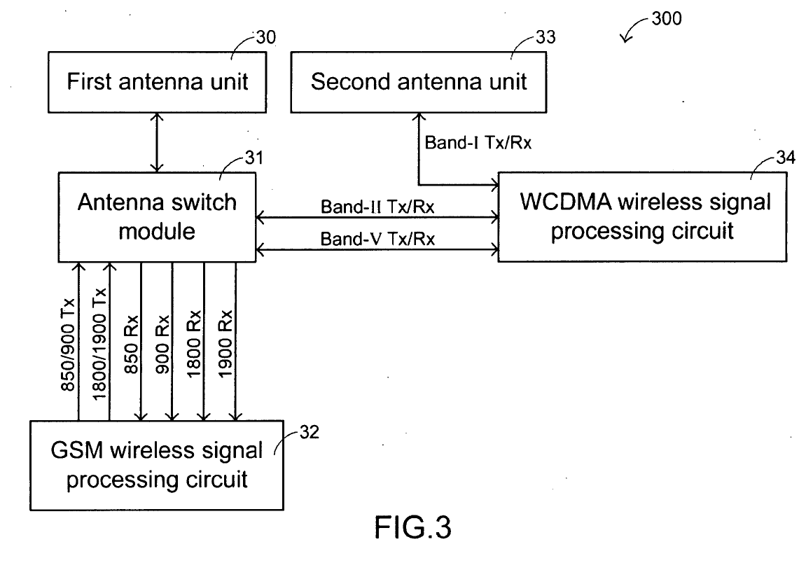

FIG. 3 is a schematic functional block diagram illustrating a mobile phone according to an embodiment of the present invention. An example of the mobile phone 300 is a multi-band communication device. That is, the signal transmission (Tx) and signal reception (Rx) of the mobile phone 300 are performed in multiple frequency bands. As shown in FIG. 3, the mobile phone 300 principally comprises an antenna switch module 31, a GSM wireless signal processing circuit 32 and a WCDMA wireless signal processing circuit 34. That is, the signal transmission and signal reception of the mobile phone 300 are performed according to the specifications defined by the WCDMA system and the GSM system.

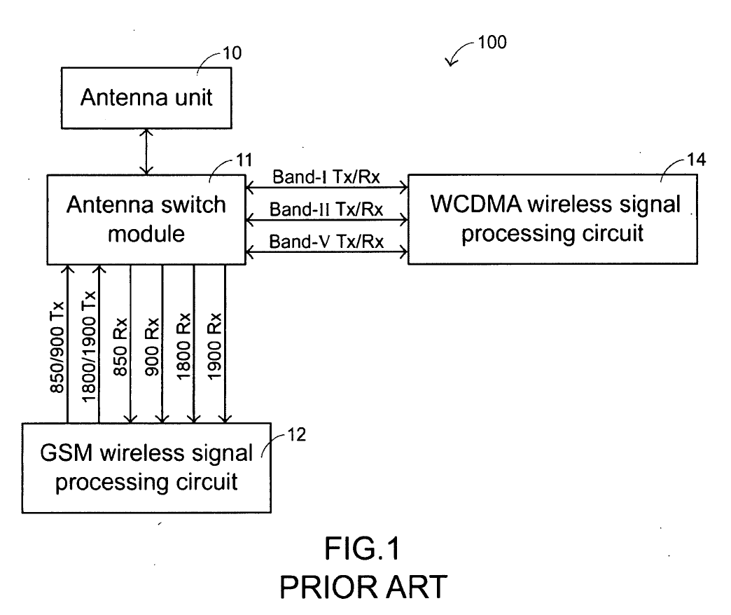

The antenna switch module 31 is in communication with the wireless signal processing circuit 32 and the WCDMA wireless signal processing circuit 34. Like the mobile phone of FIG. 1, the signal transmission (Tx) and signal reception (Rx) of the GSM wireless signal processing circuit 32 and the WCDMA wireless signal processing circuit 34 of the mobile phone 300 are performed in different frequency bands. The GSM wireless signal processing circuit 32 can be used for operating multiple first band signals. For example, the transmitter (Tx) of the GSM wireless signal processing circuit 32 is operated in the 850/900 MHz or 1800/1900 MHz frequency bands. The reception (Rx) of the GSM wireless signal processing circuit 32 is performed in the 850, 900, 1800 or 1900 MHz frequency bands. The WCDMA wireless signal processing circuit 34 is used for operating multiple second band signals. For example, the signal transmission (Tx) and signal reception (Rx) of the WCDMA wireless signal processing circuit 14 are performed in three frequency bands, e.g. Band-I (2100 MHz), Band-II (1900 MHz) and Band-V (850 MHz).

In accordance with a key feature of the present invention, the mobile phone 300 includes a first antenna unit 30 and a second antenna unit 33. The first antenna unit 30 is a multi-band antenna. The second antenna unit 33 is a single-band antenna. The first antenna unit 30 is in communication with the antenna switch module 31. The second antenna unit 33 is directly in communication with the WCDMA wireless signal processing circuit 34.

The antenna switch module 31 is used for switching the first band signals that are operable by the GSM wireless signal processing circuit 32, thereby transmitting and receiving the switched first band signals through the first antenna unit 30. In addition, the antenna switch module 31 can also switch a first portion of the second band signals that are operable by the WCDMA wireless signal processing circuit 34, thereby transmitting and receiving the switched first band signals through the first antenna unit 30. In an embodiment, the first portion of the second band signals is operated in the relatively lower-frequency band such as the Band-II (1900 MHz) and the Band-V (850 MHz).

On the other hand, the WCDMA wireless signal processing circuit 34 can operate a second portion of the second band signals, thereby directly transmitting and receiving the second portion of the second band signals through the second antenna unit 33. In an embodiment, the second portion of the second band signals is operated in the relatively higher-frequency band such as the Band-I (2100 MHz). In other words, the second portion of the second band signals needs not to be switched by the antenna switch module 31. As a consequence, the power loss or insertion loss generated during the antenna switch module switches signals in multiple frequency bands of the WCDMA system will be minimized.

Please refer to FIG. 3 again. The second portion of the second band signals is operated in the relatively higher-frequency band (e.g. Band-I (2100 MHz)) and directly transported through the second antenna unit 33. During the signal reception process, since the second antenna unit 33 is a single-band antenna, the signals received by the WCDMA wireless signal processing circuit 34 are very sharp and clear. During the signal transmission process, since the second portion of the second band signals is not switched by the antenna switch module 31, the energy consumed by the WCDMA wireless signal processing circuit 34 is very low. This low energy consumption is not detrimental to the transmitting power of the second antenna unit 33.

Since the second portion of the second band signals is not switched by the antenna switch module 31, the performance of transporting signals in the relatively higher-frequency band (e.g. Band-I (2100 MHz)) is improved. Experiments show that the mobile phone of the present invention is improved in the total radiated power (TRP) test and the total isotropic sensitivity (TIS) test.

The second antenna unit 33 supports the second portion of the second band signals. That is, the second antenna unit 33 is a single-band antenna for transmitting and receiving signals in the Band-I. Since the Band-I is the highest frequency band (e.g. 2100 MHz) of the WCDMA system, the efficacy of transporting signals in this band (e.g. 2100 MHz) is enhanced. In addition, the layout area of the second antenna unit 33 is relatively smaller, and thus the space for accommodating the second antenna unit 33 in the mobile phone 300 is saved.

The antenna switch module 31 and the first antenna unit 30 do not need to support the second portion of the second band signals, which is transported in the highest frequency band (Band-I). That is, the antenna switch module 31 and the first antenna unit 30 only support the first band signals in all frequency bands of the GSM system and the first portion of the second band signals in other frequency bands of the WCDMA system (e.g. Band-II and Band-V). Since the antenna switch module 31 and the first antenna unit 30 do not support the highest frequency band signals, the performance of transmitting signals is also satisfied after the antenna switch module 31 switches the signals.

The above embodiments are illustrated by referring to mobile phones. Nevertheless, the multi-band communication device of the present invention can be other communication device such as a smart phone or a personal digital assistant (PDA). When this multi-band communication device is operated in two different communication systems, corresponding antenna units are used to transport signals in corresponding frequency bands.

In the above embodiments, the second portion of the second band signals is transported in the highest frequency band (i.e. the Band-I) through the single-band second antenna unit. Nevertheless, the second portion of the second band signals may be transported in other frequency band, for example the Band-II or Band-V as shown in FIG. 3 or even the Band-III or Band-IV of the WCDMA system. In other words, for achieving the optimal transporting performance, the second antenna unit 33 can transmit the second portion of the second band signals in a desired frequency band of the WCDMA system.

From the above description, the multi-band communication device of the present invention can be operated in the WCDMA system and the GSM system. During the processes of switching the frequency bands of the WCDMA system and transporting signals, the transporting power loss or the insertion loss is reduced and thus the performance of transporting signals is enhanced. When this multi-band communication device is operated in two different communication systems, corresponding antenna units are used to transport signals in corresponding frequency bands and thus optimal transporting performance is achievable. The present invention can achieve the optimal transmitting performance in a desired frequency band without the need of using the frequency division filter.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-band communication device comprising:
a first wireless signal processing circuit for operating multiple first band signals;
a second wireless signal processing circuit for operating multiple second band signals;
an antenna switch module in communication with the first wireless signal processing circuit and the second wireless signal processing circuit for switching the first band signals and a first portion of the second band signals;
a first antenna unit in communication with the antenna switch module; and
a second antenna unit in communication with the second wireless signal processing circuit.

2. The multi-band communication device according to claim 1 wherein the first wireless signal processing circuit is a GSM (Global System for Mobile Communications) wireless signal processing circuit.

3. The multi-band communication device according to claim 1 wherein the second wireless signal processing circuit is a WCDMA (Wideband Code Division Multiple Access) wireless signal processing circuit.

4. The multi-band communication device according to claim 1 wherein the second antenna unit transmits and receives the second band signals in the highest frequency band.

5. The multi-band communication device according to claim 1 wherein the second antenna unit supports a second portion of the second band signals.

6. The multi-band communication device according to claim 1 wherein the first antenna unit supports the first band signals and the first portion of the second band signals.

7. The multi-band communication device according to claim 1 wherein the second antenna unit is a single-band antenna.

8. The multi-band communication device according to claim 1 wherein the first antenna unit is a multi-band antenna.

9. The multi-band communication device according to claim 1 wherein the multi-band communication device is selected from a mobile phone, a smart phone or a personal digital assistant.
